(19) United States
(12) Patent Application Publication
(10) Pub. No.: US 2016/0214447 A1
(43) Pub. Date: Jul. 28, 2016

(54) DEVICE FOR DETACHABLY FIXING TWO PARTS OF A BICYCLE PUMP TO EACH OTHER, WHICH PARTS CAN BE MOVED IN RELATION TO EACH OTHER

(71) Applicant: RE.MO.BIC GMBH, Mistelbach (AT)

(72) Inventor: Alexander HAAGER, Mistelbach (AT)

(73) Assignee: re.mo.bic. GmbH, Mistelbach an der Zaya (AT)

(21) Appl. No.: 14/915,998

(22) PCT Filed: Sep. 2, 2013
(86) PCT No.: PCT/AT2013/000142

§ 371 Date: Mar. 2, 2016

(51) Int. Cl. B60C 23/10

(52) U.S. Cl. CPC B60C 23/105

(57) ABSTRACT

In a device for detachably fixing to each other two relatively movable parts of a device for generating compressed air, in particular a bicycle pump, a substantially cylindrical end region of the pump piston facing a bicycle saddle is designed to have a diameter enlarged relative to the part of the pump piston guided in the sleeve, the region of enlarged diameter and a free end region of the sleeve are surrounded by a union nut provided with an internal thread in an end region and the internal thread of the union nut is detachably connectable to a thread arranged on the sleeve or on the region of enlarged diameter of the pump piston, in order to design both the union nut and one of the two relatively movable parts of the seatpost with interacting stops.

The present invention relates to a device for detachably fixing to each other two relatively movable parts of a device for generating compressed air for filling bicycle tires, which device forms a seatpost, wherein the two relatively movable parts of the seatpost are formed by a sleeve surrounding a pump rod and by a pump piston.

### BACKGROUND OF THE INVENTION

Bicycle pumps that are formed as components of bicycles are known in various configurations or designs and are either integrated in the frame, fork or seatpost of a bicycle or form, for instance, the seatpost such that a bicycle saddle can be directly fixed to the bicycle pump via a special fastening device.

Such a device has, for instance, become known from EP 2 288 535 E1, in which the bicycle pump can be integrated in various portions of a bicycle, such as the fork, or the pump forms the seatpost for the bicycle saddle. That known device involves the drawback that the relatively movable parts of the device forming a seatpost and used for generating compressed air are fixed by a locking means comprised of a locking bolt. In operation of a bicycle provided with such a seatpost and, in particular, when riding on uneven terrain, massive shocks are exerted on that locking bolt, thus causing the stud of the locking bolt to break or bend after relatively short operating times, whereupon the bicycle pump either has to be repaired or has become useless to such an extent that the pump elements, which are per se completely free of damage, have to be replaced lust as the whole seatpost.

### BRIEF SUMMARY OF THE INVENTION

The present invention aims to provide a device for detachably fixing to each other two relatively movable parts of a seatpost-forming device for generating compressed air, which during riding will reliably hold the relatively movable parts in a locked and interconnected state even under the highest loads, and which is easily and reliably openable and closeable plurality of times.

To solve this object, the device according to the invention is essentially characterized in that a substantially cylindrical end region of the pump piston facing a bicycle saddle is designed to have a diameter enlarged relative to the part of the pump piston guided in the sleeve, that the region of enlarged diameter and a free end region of the sleeve are surrounded by a union nut provided with an internal thread in an end region and the internal thread of the union nut is detachably connectable to a thread arranged on the sleeve or on the region of enlarged diameter of the pump piston, that the union nut comprises an annular stop located adjacent the internal thread and reducing its inner diameter, and that a stop enlarging an outer diameter of either the sleeve or the region of enlarged diameter of the pump piston is configured for interaction with the stop of the union nut. In that a substantially cylindrical end region of the pump piston facing a bicycle saddle is designed to have a diameter enlarged relative to the part of the pump piston guided in the sleeve, it is ensured that accidental striking, which is in particular caused by loads, of a lower end region of the sleeve against other elements of the bicycle pump will be avoided so as to safely prevent the destruction of bicycle pump elements arranged within the sleeve, e.g. a pump rod or the like. In that the region of enlarged diameter and a free end region of the sleeve are, moreover, surrounded by a union nut provided with an internal thread in an end region and the internal thread of the union nut is detachably connectable to a thread arranged on the sleeve or on the region of enlarged diameter of the pump piston, a connection is created between the union nut and one of the two relatively movable parts, which connection can neither be destroyed nor inadvertently undone under shocks and, in particular, stress due to shocks, as would, for instance, occur when riding a mountain bike. In that, furthermore, the union nut itself comprises an annular stop located adjacent the internal thread and reducing its inner diameter, and a stop enlarging an outer diameter of either the sleeve or the region of enlarged diameter of the pump piston is configured for interaction with the stop of the union nut, a connection is created between the two relatively movable parts of a bicycle pump, which connection is, in particular, completely insensitive to impact loads. By fixing the union nut to a stop of one of the two relatively movable Darts and tightening said union nut on the second one of the two relatively movable parts, a detachable fixation to each other of the two relatively movable parts has become possible, which can be released any time, and which detachable connection can neither be torn out nor bent even under the highest loads such that a seatpost comparable to a conventional seatpost in terms of service life and resilience is provided, which can additionally be used as a bicycle pump so as to not only reduce the overall weight of the bicycle but also provide an elegant and esthetic solution for fixing a bicycle pump to or in a bicycle, without requiring any deterioration or weakening of the bicycle frame, for instance, by forming holes in the frame, slots for moving elements of the bicycle pump and the like.

It goes without saving that such a bicycle pump configured as a seatpost can, of course, be fixed in different heights like any other conventional seatpost in order to adapt the seat height of the bicycle to its user.

In order to ensure, in particular in the opened state of the union nut, i.e. while operating the device for generating compressed air, or when there is readiness to inflate a bicycle tire, that the union nut will not, for instance, shift around at every pump movement and, for instance, cause scratches in the lacquer of the seatpost so as to not only lead to an esthetic impairment but also shorten the service life of the pump, the invention is further developed to the effect that the union nut is arranged to surround the sleeve, and that the sleeve, at a distance from the region of enlarged diameter, comprises a further element enlarging the outer diameter of the sleeve. Such inadvertent displacement of the sleeve is prevented by providing an element enlarging the outer diameter of the sleeve, which element serves as a stop for the union nut to prevent the union nut from randomly moving along the sleeve.

In that, as in correspondence with a further development of the invention, it is proceeded such that said further element enlarging the outer diameter of the sleeve is comprised of a resettable element inserted in a groove of the sleeve, in particular an elastic ring or snap ring, a noise reduction of a still possible movement, of the union nut can be achieved, in particular where an elastic ring is provided, so that any clattering or clanking noise of the union nut will be avoided even during pumping. It has thus become possible to provide not only a secure hold between the movable parts of the bicycle pump but also a device that is easy to operate and, in addition to offering an esthetic appearance, will safely and reliably function, and be readily operable, when used for both bicycle races and hobby activities.

In order to enhance safety and, in particular, also prevent any inadvertent loosening of the union nut, the invention is further developed to the effect that the union nut comprises at least one opening, in particular threaded opening, passing through the stop and a holding pin is inserted, in particular screwed, into said opening. By providing such a holding pin passing through an opening in the union nut, inadvertent turning of the union nut will be avoided while, at the same time, ensuring that no load whatsoever and, in particular, no perpendicularly acting forces will be exerted on the holding pin such that accidental bending of the holding pin as has occurred in prior art configurations will be prevented.

According to a further development of the invention, the device is further devised such that the sleeve and the substantially cylindrical end region of the pump piston are provided with cooperating anti-rotation elements. By providing anti-rotation elements in both the substantially cylindrical end region of the pump piston and the sleeve, it is safeguarded that these elements cannot be arbitrarily rotated relative to each other, and hence require a realignment of the saddle, which is fixed to the seatpost forming the bicycle pump, after every operation of the bicycle pump, which would not only mean an unnecessary waste of time but, in particular, prevent a user from frequently using the pump, since this would involve an unnecessary amount of work.

Safe anti-rotation elements that are nondestructive even under the highest loads according to the present invention are configured such that the anti-rotation elements are comprised of at least one pair of mutually positively engageable regions, in particular flattenings, which deviate from the cylindrical shape of the sleeve and the substantially cylindrical end region of the pump piston. By such anti-rotation elements comprised of mutually positively engageable regions, in particular flattenings, which deviate from the cylindrical shape of the sleeve and the substantially cylindrical end region of the pump piston, it has become possible to ensure that the pump piston can be inserted into the sleeve in just a single position, which position corresponds to the proper alignment of the bicycle saddle, without, at the same time, affecting the operability of the union nut in any manner whatsoever. By providing two pairs of cooperating anti-rotation elements, in particular anti-rotation elements enclosing an angle smaller than 180°, it is ensured that only a single position of the bicycle saddle is actually enabled rather than allowing the bicycle saddle to be fixed to the seatpost, for instance, in a manner offset by 180° relative to the operating position, so as to provide a particularly quick and reliable device that is, in particular, easy to operate also by inexperienced users or children.

Further anti-rotation elements that operate equally reliably and effectively according to the invention are configured such that the anti-rotation elements are comprised of at least one pair of mutually engageable projections and recesses. Such an anti-rotation element configuration will also provide proper positioning of the bicycle saddle relative to the bicycle frame, wherein such anti-rotation elements will not affect the mode of operation of the fixing device according to the invention in any manner whatsoever and, moreover, enable extremely long service lives without impairing functioning.

### BRIEF DESCRIPTION OF THE SEVERAL VIEWS OF THE DRAWINGS

In the following, the invention will be explained in more detail by way of exemplary embodiments illustrated in the drawing. Therein:

FIG. 1 illustrates a first configuration of a device according to the invention; and

FIG. 2 illustrates a further configuration of a device according to the invention,

### DETAILED DESCRIPTION OF THE INVENTION

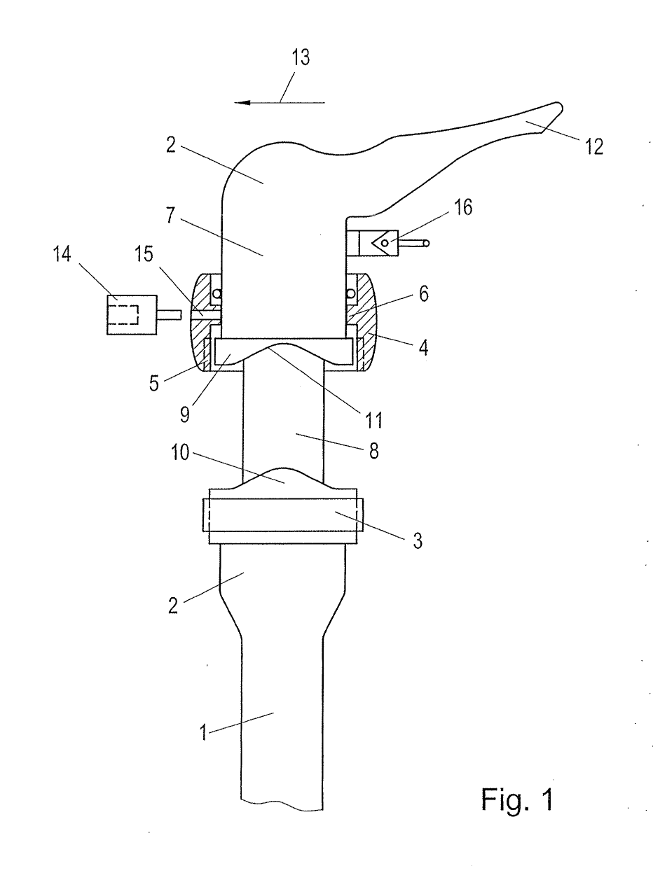

FIG. 1 is a schematic illustration of a part of a bicycle pump forming a seatpost, in which an end region of a sleeve 1, which faces a bicycle saddle not illustrated in the drawing, is provided with an end region 2 having an enlarged diameter relative to the sleeve 1. This end region 2, which has an enlarged diameter relative to the sleeve 1, is further provided with a thread 3 so as to enable a union nut 4 to be detachably fixed to said thread 3.

The union nut 4 comprises not only an internal thread 5 complementary to the thread 3, but also a region of reduced inner diameter 6, which is provided on a thickened end region 7 of the pump piston 8, as a holding element or stop of the union nut 4. The thickened end region 7 of the pump piston 8, moreover, comprises a stop element. 9 enlarging even further an outer diameter 7 and interacting with the region 6 of the union nut 4 so as to prevent at any rate a loss of the union nut 4 or inadvertent displacement of the union nut 4, e.g. over the sleeve 1. In order to prevent unintended rotation of the sleeve and the pump piston 8 relative to each other in a closed state, i.e. in a mutually abutting state of the two thickened end regions 7 and 2 of the pump elements, a projection 10 having a rounded contour is, moreover, formed in the end region 2 of the sleeve 1. This projection 10 cooperates with a recess 11 formed in the thickened end region 7 of the pump piston 8 and prevents the pump piston 8 from rotating relative to the sleeve 1. Such an anti-rotation element ensures the proper positioning. of the bicycle saddle (not illustrated). In this respect, the bicycle saddle should be oriented in such a manner that a seat surface of the saddle rests on, or is fastened to, the projection 12 and oriented in the direction of part 13.

For further fastening the union nut and, in particular, in order to ensure that the union nut 4 will not be inadvertently rotated, a holding pin 14 is provided, which can be fixed in a corresponding recess 15 of the union nut 4 by inserting or screwing. As is schematically illustrated, the holding pin 14 can in this case, for instance, be provided with reflectors or a LED on its outwardly directed, free end surface so as to provide a practical effect and, for instance, constitute the reflectors that are required by law. Finally, FIG. 1. schematically illustrates a valve 16, which serves to deliver compressed air and, in particular, to connect to a suitable filling hose (not illustrated).

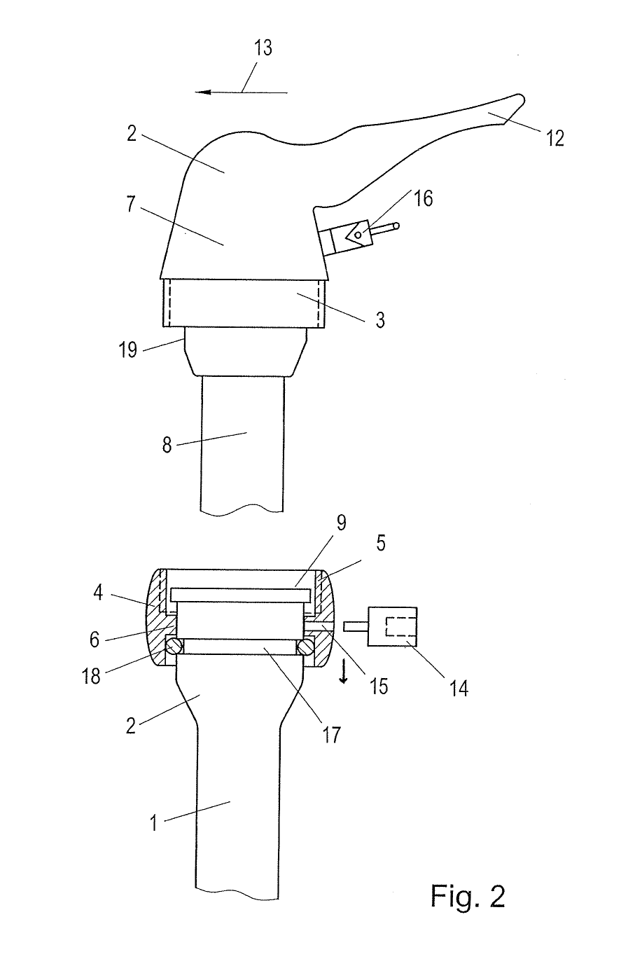

In FIG. 2, the reference numerals of FIG. 2 have been retained to the extent possible, and the description of parts already described in FIG. 1 is not repeated in FIG. 2.

In the configuration according to FIG. 2, the union nut 4 is arranged in the thickened region 2 of the sleeve 1 so as to be encompassed.

In order to safely prevent inadvertent shifting or dropping of the union nut 4 in the sense of arrow 16, in particular in its opened state, an annular groove 17 is additionally formed in the thickened region 2, in which annular groove 17 a ring protruding beyond the depth of the annular groove 17, in particular a rubber ring or snap ring 18, is, for instance, inserted so as to avoid the inadvertent displacement of the union nut 4 in the sense of arrow 16.

In the illustration according to FIG. 2, the stop 9 is formed in the region of the sleeve 1 in order to avoid inadvertent displacement of the union nut 4 over the upper thickened end region 2 of the sleeve 1. For the safe fixation of the union nut 4 to the pump piston 8, which is movable relative to the sleeve 1, the thread 3 for fixing the union nut 4 is formed in the thickened end region 7 of the pump piston 3.

In the illustration of FIG. 2, a modified variant of an anti-rotation device is finally chosen, wherein, in this case, mutually interacting flattenings are, in particular, provided both on the thickened end region 7 of the pump piston 8 and in the thickened end region 2 of the sleeve 1, as cannot be seen in the drawing. The flattening 19 provided in the thickened end region 7 of the pump piston 8 is visible. By providing such flattenings 19, it is ensured that the pump piston 8 can be inserted into the sleeve 1 in just a single position, whereby any unintended rotation of a saddle fixed to the bracket provided therefor, which is also formed in one piece with the upper end region 7 of the pump piston 8, will be safely prevented.

The mode of functioning described in FIG. 1 applies to all further parts.

1. A device for detachably fixing to each other two relatively movable parts of a device for generating compressed air for filling bicycle tires, which device forms a seatpost, wherein the two relatively movable parts of the seatpost are formed by a sleeve surrounding a pump rod and by a pump piston, wherein a substantially cylindrical end region of the pump piston facing a bicycle saddle is designed to have a diameter enlarged relative to the part of the pump piston guided in the sleeve, that the region of enlarged diameter and a free end region of the sleeve are surrounded by a union nut provided with an internal thread in an end region and the internal thread of the union nut is detachably connectable to a thread arranged on the sleeve or on the region of enlarged diameter of the pump piston, that the union nut comprises an annular stop located adjacent the internal thread, and reducing its inner diameter, and that a stop enlarging an outer diameter of either the sleeve or the region of enlarged diameter of the pump piston is configured for interaction with the stop of the union nut.

2. The device according claim 1, wherein the union nut is arranged to surround the sleeve, and that the sleeve, at a distance from the region of enlarged diameter, comprises a further element enlarging the outer diameter of the sleeve.

3. The device according to claim 1, wherein said further element enlarging the outer diameter of the sleeve is comprised of a resettable element inserted in a groove of the sleeve, in particular an elastic ring or snap ring.

4. The device according to claim 1, wherein the union nut comprises at least one opening, in particular threaded opening, passing through the stop and a holding pin is inserted, in particular screwed, into said opening.

5. The device according to claim 1, wherein the sleeve and the substantially cylindrical end region of the pump piston are provided with cooperating anti-rotation elements.

6. The device according to claim 6, wherein the anti-rotation elements are comprised of at least one pair of mutually positively engageable regions, in particular flattenings, which deviate from the cylindrical shape of the sleeve and the substantially cylindrical end region of the pump piston.

7. The device according to claim 6, wherein the anti-rotation elements are comprised of at least one pair of mutually engageable projections and recesses having, in particular, rounded contours.
